(19) United States
(12) Patent Application Publication
(10) Pub. No.: US 2012/0143888 A1
(43) Pub. Date: Jun. 7, 2012

(54) AUTOMATIC UPDATING OF AN EXISTING DOCUMENT USING SAVE-IN FUNCTIONALITY

(76) Inventors: Jagdeesh Manickam Neelakantan, Bangalore (IN); Rahul Chandra Kini, Bangalore (IN); Thomas B. Kuruvila, Bangalore (IN)

(21) Appl. No.: 12/961,556

(22) Filed: Dec. 7, 2010

(51) Int. Cl. G06F 17/30

(52) U.S. Cl. 707/758; 707/E17.124

(57) ABSTRACT

Various embodiments of systems and methods for automatically updating an existing document associated with an analytic report using save-in functionality are described herein. A selection of a save-in option is received for the analytic report. Further, meta-data associated with the analytic report is retrieved. The meta-data includes location information of the existing document associated with the analytic report and mapping information of the analytic report and the existing document. The existing document is a document previously exported from the analytic report using a save-as option. Also, the existing document can be a document provided using a change source option. Furthermore, the analytic report and the existing document are compared using the mapping information and the existing document is updated using the analytic report based on the comparison.

### FIELD

Embodiments generally relate to computer systems and more particularly to methods and systems for automatically updating an existing document associated with an analytic report using save-in functionality.

### BACKGROUND

Analytic reports provide business users an easy to use interactive and flexible user interface for building and analyzing reports. For example, analytic reports such as Web Intelligence® reports and Crystal Reports® by SAP® provide a flexible platform for the user to create reports in real time. Often, the analytic report is exported as a document for manually adding additional information such as comments for internal use or for further processing. However, the data in the analytic report is not static and changes with respect to time. Therefore, a new document needs to be exported from the refreshed analytic report and the difference between the two exported documents needs to be manually appended to one of the two documents.

In general, apart from manually comparing the two exported documents and updating one of the two documents, there exists no method to automatically find the data difference and merge it into a single document. Therefore, automatically updating the previously exported document with the information in the refreshed analytic report without exporting another document is desirable.

### SUMMARY

Various embodiments of systems and methods for automatically updating an existing document associated with an analytic report using save-in functionality are described herein. A selection of a save-in option is received for the analytic report. Further, meta-data associated with the analytic report is retrieved. The meta-data includes location information of the existing document associated with the analytic report and mapping information of the analytic report and the existing document. The existing document is a document previously exported from the analytic report using a save-as option. Also, the existing document can be a document provided using a change source option. Furthermore, the analytic report and the existing document are compared using the mapping information, and the existing document is updated using the analytic report based on the comparison.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a method of automatically updating an existing document associated with an analytic report using a save-in option, according to an embodiment.

FIG. 2 is a flow diagram illustrating a method of storing meta-data associated with an analytic report using a save-as option, according to an embodiment.

FIG. 3 is an exemplary analytic report, according to an embodiment.

FIG. 4A is an exemplary exported document of the analytic report of FIG. 3, according to an embodiment.

FIG. 4B is an exemplary augmented existing document of FIG. 4A, according to an embodiment.

FIG. 5 is an exemplary refreshed analytic report of FIG. 3, according to an embodiment.

FIGS. 6A and 6B are exemplary user interfaces (UI) illustrating mapping information, according to an embodiment.

FIG. 7 is an exemplary existing document of FIG. 4B updated using a save-in option in the analytic report of FIG. 5, according to an embodiment.

FIG. 8 is another exemplary refreshed analytic report of FIG. 3, according to an embodiment.

FIG. 9 is a block diagram illustrating a computing environment in which the techniques described for automatically updating an existing document associated with an analytic report using a save-in option, according to an embodiment.

### DETAILED DESCRIPTION

Embodiments of techniques for automatically updating an existing document associated with an analytic report using save-in functionality are described herein. The analytic report includes information automatically retrieved (i.e., in response to computer executable instructions) from a data source (e.g., a database, a data warehouse, and the like), where the information is processed, structured, and formatted in accordance with a report schema. Examples of the analytic report are Crystal Reports® and Web Intelligence® reports by SAP®, and the like. The existing document includes an exported document from the analytic report or a document associated with the analytic report. Existing document can be of a format such as, a spreadsheet, e.g., Google® Spreadsheets, Microsoft® Excel®, and the like, or other documents, e.g., Adobe® Illustrator®, and the like. The analytic report is exported to a document by a user to add further data or elements (e.g., comments) in the exported document and pass the document for further processing. The user refers to an agent, a human, a computer, other mechanism or actors capable of providing instructions to export the analytic report and further add data or elements.

According to an embodiment, the exported existing document is updated with a real time analytic report using a save-in option instead of exporting another document for the real time analytic report. Therefore, additional elements as added by the user as well as additional elements in the real time analytic report can be easily accessed in a single document.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

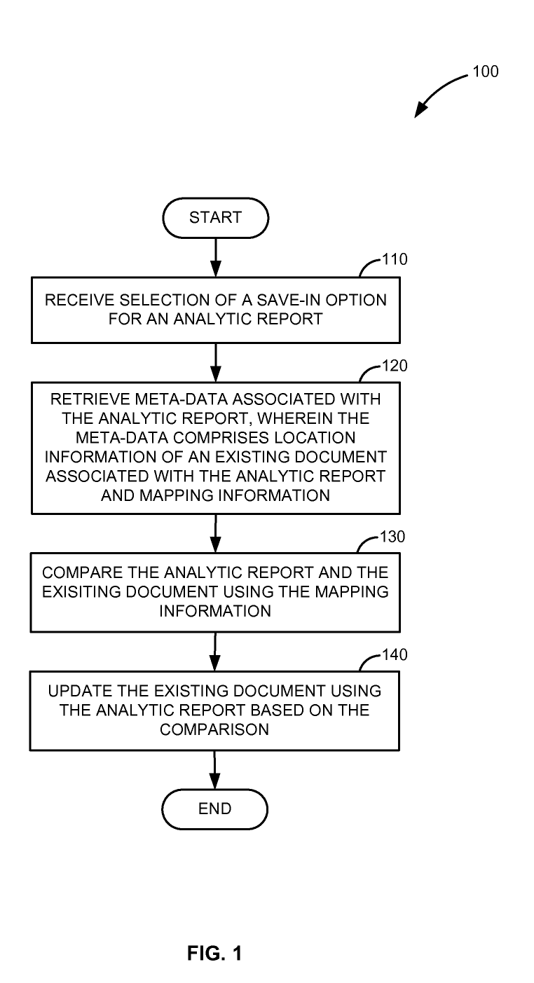

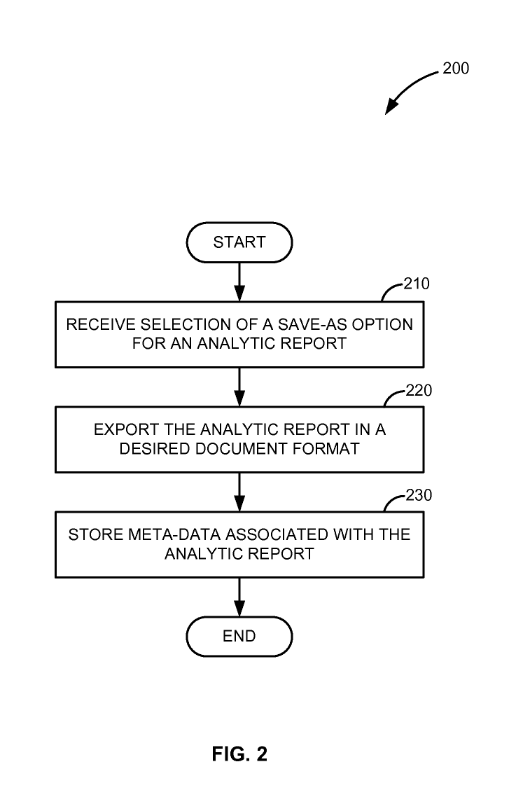

FIG. 1 is a flow diagram 100 illustrating a method of automatically updating an existing document associated with an analytic report using a save-in option, according to an embodiment. At step 110, a selection of a save-in option for an analytic report is received. In one embodiment, the analytic report is a real time business report, which retrieves data from multiple data sources and provides a structured report for a user for easy business analysis. At step 120, meta-data associated with the analytic report is retrieved. In one embodiment, the meta-data includes location information of the existing document associated with the analytic report and mapping information of the analytic report and the existing document. The mapping information includes information associated with mapping of one or more dimensions of the analytic report with corresponding one or more dimensions of the existing document. In one exemplary embodiment, the meta-data is stored in the analytic report when the analytic report is previously exported using a save-as option. The method of storing the meta-data in the analytic report using the save-as option is described in greater detail in FIG. 2.

In one embodiment, the existing document can be one of a document previously exported from the analytic report using the save-as option and a document provided using a change source option. In other words, any existing document can be manually provided for the process of updating the existing document using the save-in option. For the existing document provided using the change source option, the user may have to define the mapping information manually.

At step 130, the analytic report and the existing document are compared using the mapping information. In one embodiment, the analytic report and the existing document are converted into a comparable format before comparing. Further, the one or more dimensions (e.g., one or more headers) of the analytic report are compared with corresponding one or more dimensions (e.g., corresponding one or more headers) of the existing document using the mapping information. If the one or more dimensions of the analytic report are mismatched with the corresponding one or more dimensions of the existing document, the mapping information can be defined manually. Furthermore, one or more elements of the analytic report are compared with corresponding one or more elements of the existing document. The one or more elements include primary elements and other elements. The primary elements are the measures defining the one or more dimensions.

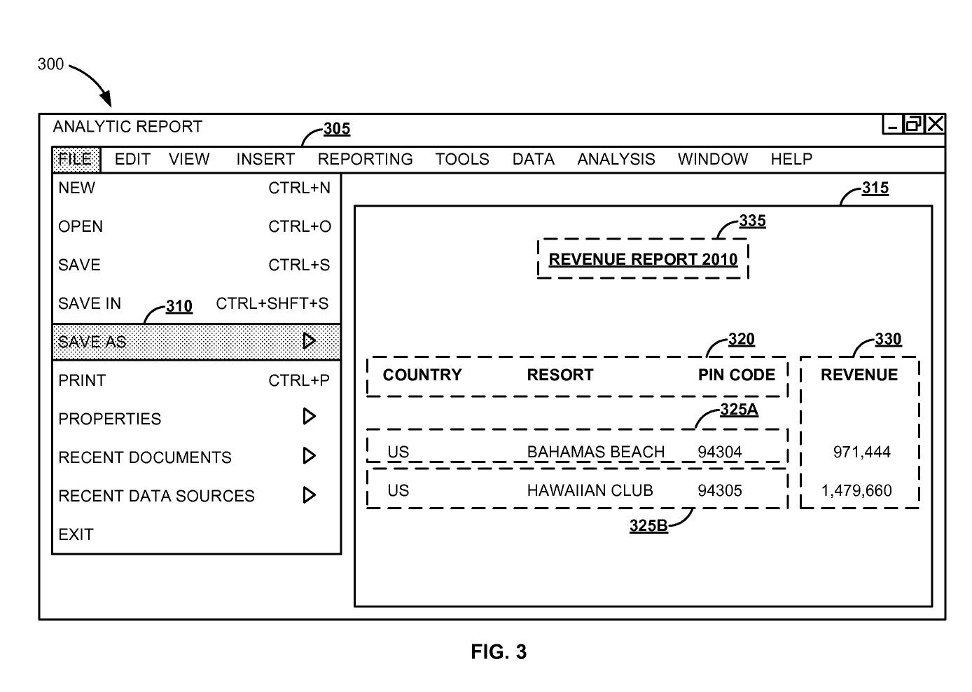

At step 140, the existing document is updated using the analytic report based on the comparison. In one embodiment, updating the existing document using the analytic report includes at least one of appending additional data or elements into the existing document from the analytic report and modifying the existing document by one of retaining the existing document and over writing the existing document. In other words, if there is any mismatch in the primary elements, the existing document is appended with a new element. And, if there is any mismatch in the other elements, an option is provided to modify the existing document accordingly or to retain the existing document as it is. Automatically updating the existing document using the save-in option is illustrated with examples shown in FIGS. 3 to 7.

FIG. 2 is a flow diagram 200 illustrating a method of storing meta-data associated with an analytic report using a save-as option, according to an embodiment. At step 210, a selection of a save-as option for the analytic report is received. At step 220, the analytic report is exported in a desired document format such as a spreadsheet, e.g., Google® Spreadsheets, Microsoft® Excel®, and the like, or other documents, e.g., Adobe® Illustrator®, and the like. In other words, the analytic report can be exported as a document for adding further information or elements into the exported document for further processing. For example, if the analytic report includes a revenue report for a year, the concerned person can add comments on the resulted revenue in the exported document and pass the document for further analysis.

At step 230, meta-data associated with the analytic report is stored. In one embodiment, the meta-data includes location information of the exported document and mapping information of the analytic report and the exported document. i.e., when the analytic report is exported, the location of such exported document is stored in the analytic report. Further, the mapping information includes information associated with mapping of one or more dimensions of the analytic report with corresponding one or more dimensions of the exported document. For example, one or more headers of the analytic report mapped with corresponding one or more headers of the exported document. Storing meta-data in the analytic report is described in greater detail in FIG. 3.

FIG. 3 is an exemplary analytic report 300, according to an embodiment. The analytic report 300 includes a menu bar 305, and a canvas 315 for displaying content or data or elements of the analytic report 300. The menu bar 305 includes one or more options such as save, save-in, save-as 310, and the like. The canvas includes one or more elements such as a header of the analytic report 300 (e.g., ‘revenue report 2010’ 335), one or more dimensions (e.g., ‘country’, ‘resort’ and ‘pin code’ as in 320), a plurality of primary elements (“‘US’ ‘Bahamas Beach’, ‘94304’” 325A and “‘US’, ‘Hawaiian Club’ ‘94305’” 325B), and other elements (e.g., ‘revenue’, ‘971,444’, and ‘1,479,660’).

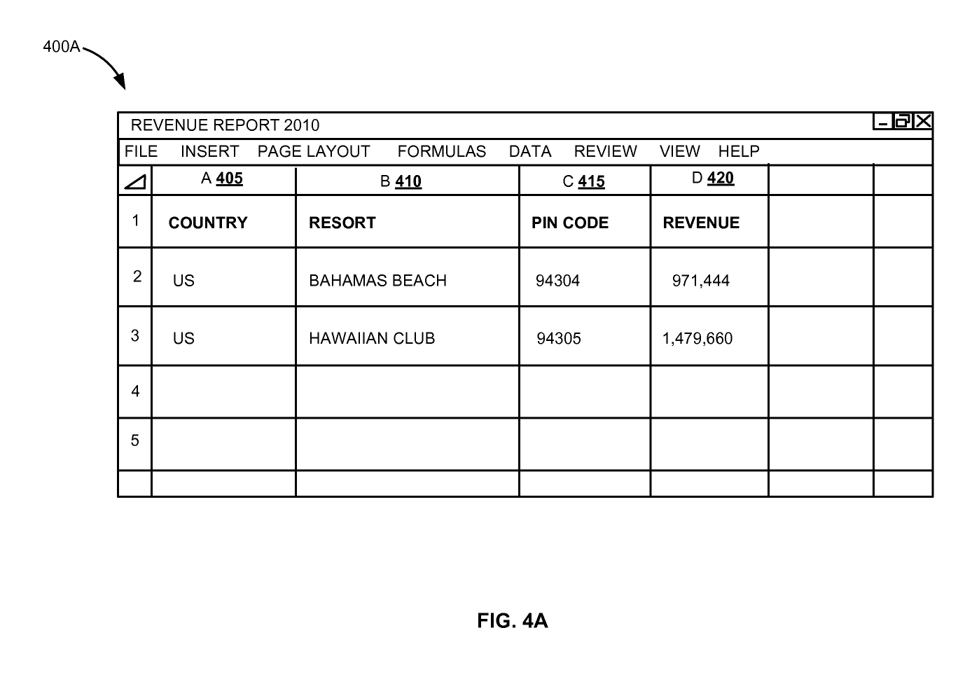

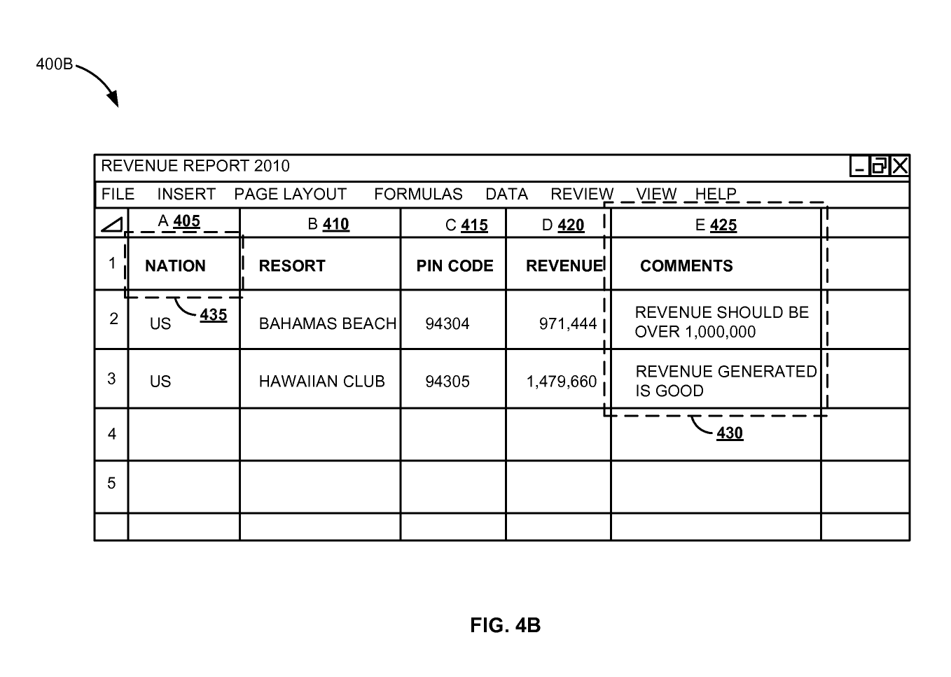

In one embodiment, when the save-as 310 option is selected, the analytic report 300 is exported to a desired document format such as a spreadsheet, e.g., Google® Spreadsheets, Microsoft® Excel®, and the like, or other documents, e.g., Adobe® Illustrator®, and the like. Also, meta-data associated with the analytic report 300 is stored when the save-as 310 option is selected. The meta-data includes location information of the exported document and mapping information of the analytic report 300 and the exported document. i.e., when the analytic report 300 is exported, the location of such exported document is stored in the analytic report 300. Further, the mapping information includes information associated with mapping of one or more dimensions of the analytic report 300 with corresponding one or more dimensions of the exported document. For example, information associated with mapping of ‘country’, ‘resort’ and ‘pin code’ as in 320 with corresponding one or more headers of the exported document are stored as mapping information. An exemplary exported document is described in greater detail in FIG. 4A

FIG. 4A is an exemplary exported document 400A of the analytic report 300 of FIG. 3 according to an embodiment. In one exemplary embodiment, the analytic report 300 is exported as a Microsoft® Excel® document 400A. In one embodiment, meta-data stored in the analytic report 300 of FIG. 3 includes location of the exported document 400A and mapping information. The mapping information includes mapping of one or more dimensions, i.e., ‘country’ (of analytic report 300) is mapped to column A 405 (of Excel® document 400A), ‘resort’ (of analytic report 300) is mapped to column B 410 (of Excel® document 400A), and ‘pin code’ (of analytic report 300) is mapped to column C 415 (of Excel® document 400A). Later, when the content of the analytic report 300 is amended, the meta-data associated with the analytic report 300 is retrieved to update the existing Excel® document 400A automatically.

FIG. 4B is an exemplary augmented existing document 400B of FIG. 4A, according to an embodiment. For example, additional elements such as an additional column E 425 as in 430 is manually fed into the exported report 400A. Also, one of the columns, i.e., header of column A 405, is modified from ‘country’ to ‘nation’ as in 435. Since the augmented existing document 400B is the latest document associated with the analytic report 300, the augmented existing document 400B is updated automatically when a save-in option is selected in the analytic report 300.

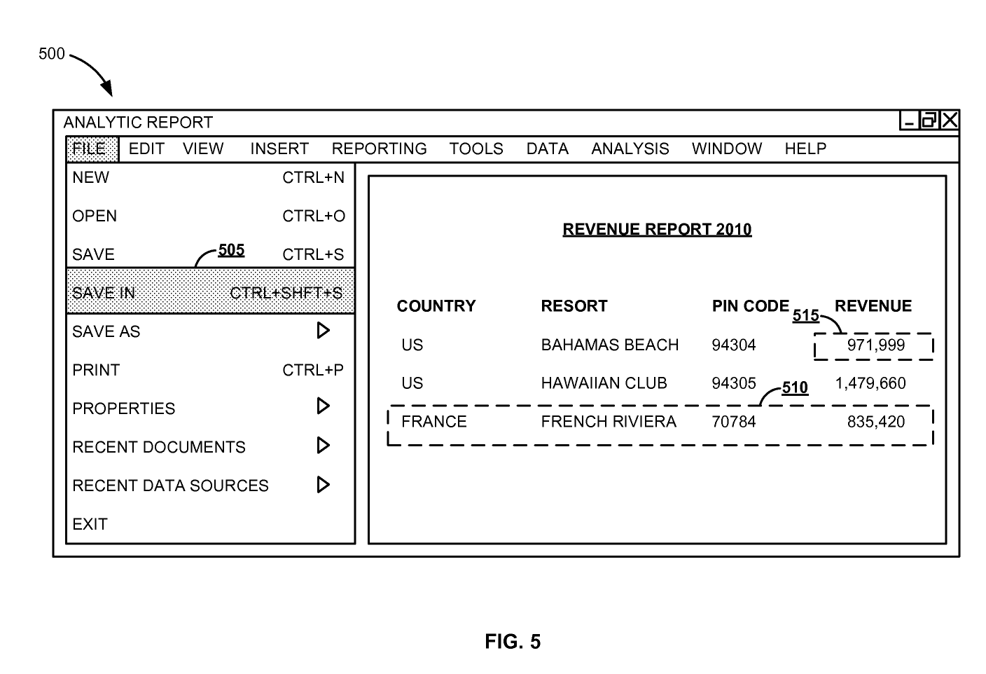

FIG. 5 is an exemplary refreshed analytic report 500, according to an embodiment. The analytic report 300 of FIG. 3 is now refreshed and the refreshed analytic report 500 includes additional elements 510 and an element ‘971,999’ 515 is an updated element compared to a corresponding element in FIG. 3. In one embodiment, to update an existing document 400B of FIG. 4B, a save-in 505 option is selected.

In one embodiment, when the save-in 505 option is selected, meta-data stored with the analytic report 500 is retrieved (the meta-data stored in the analytic report 300 of FIG. 3 remains as the meta-data of the analytic report 500). The meta-data includes location information of the existing document 400B of FIG. 4B and mapping information.

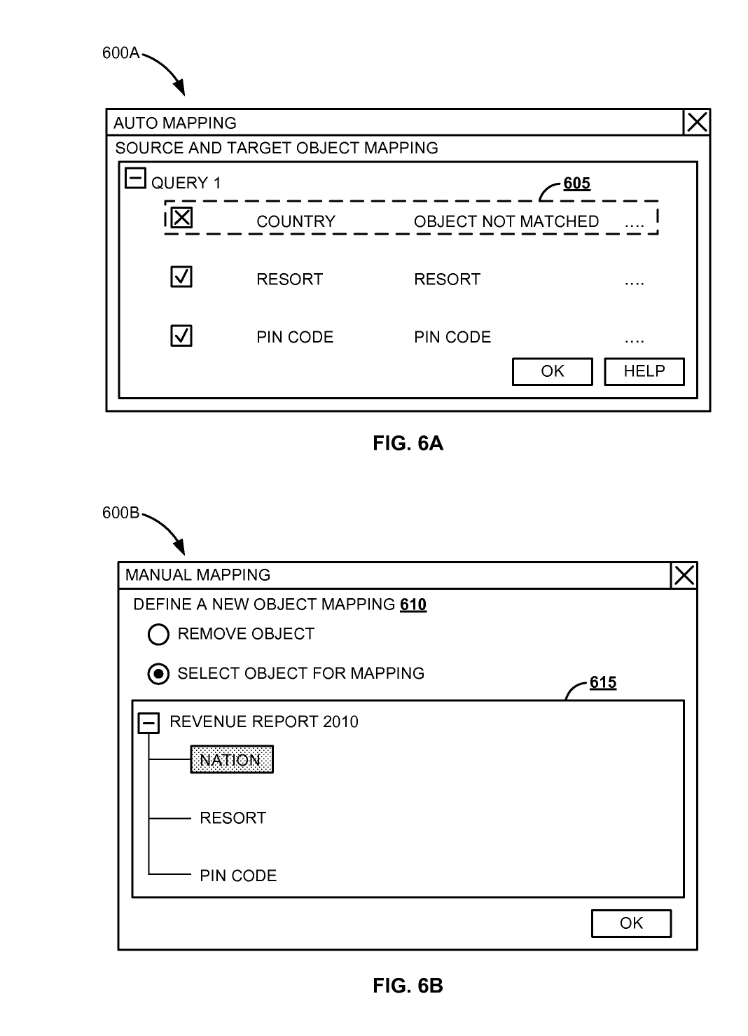

In one embodiment, the analytic report 500 and the existing document 400B are compared using the mapping information. In one embodiment, the analytic report and the existing document are converted into a comparable format such as Extensible Markup Language (XML) format before comparing. Further, the one or more dimensions of the analytic report are compared with corresponding one or more dimensions of the existing document using the mapping information. For example, ‘country’, ‘resort’ and ‘pin code’ of the analytic report 500 are compared with ‘nation’, ‘resort’, and ‘pin code’ of the existing document 400B. Since the mapped information between ‘country’ and ‘nation’ is not matching, a user is provided an option to map the corresponding dimension, which is described in greater detail in FIGS. 6A and 6B.

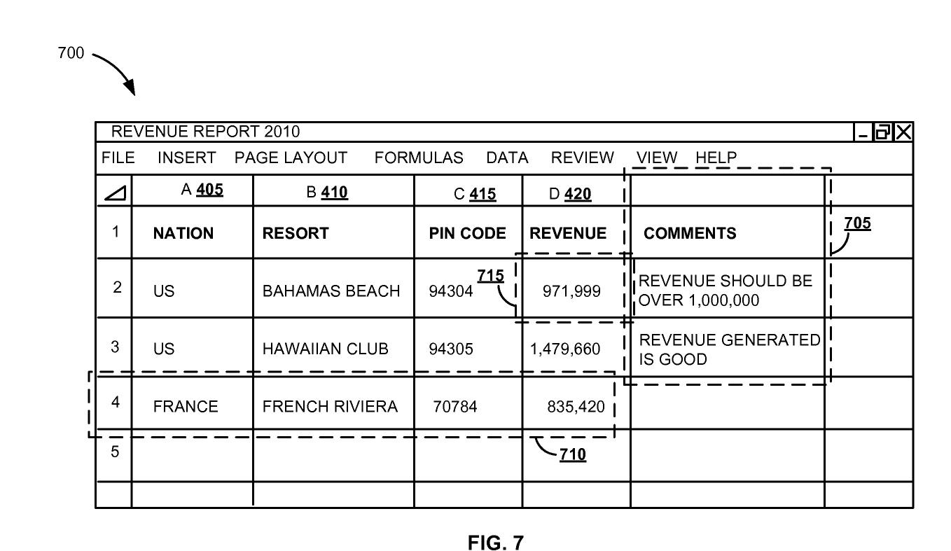

Further, one or more elements of the analytic report 500 with corresponding one or more elements of the existing document 400B are compared. For example, primary elements “‘US’ ‘Bahamas Beach’, ‘94304’” and “‘US’, ‘Hawaiian Club’ ‘94305’” of the analytic report 500 are compared with the corresponding primary elements of the existing document 400B. In one exemplary embodiment, optimized list of the primary elements can be found out, so the comparison of elements can be minimized. For example, pin code ‘94304’ may not change for the ‘Bahamas Beach’ at ‘US’, therefore the pin code ‘94304’ need not be compared during comparison of primary elements. Further, the other elements such as ‘971,999’, ‘1,479,660’ of the analytic report 500 are compared with the corresponding elements of the existing document 400B. The existing document 400B is updated using the analytic report 500 based on the comparison. For example, the existing document 400B is appended to include the additional elements 510 of the analytic report 500. Further, a mismatch is found between the element ‘971,999’ 515 of the analytic report 500 and a corresponding element ‘971,444’ of the existing document 400B. Therefore, an option is provided to the user either to retain the existing document 400B as it is or to update the corresponding element. The updated existing document 400B using the analytic report 500 is shown in FIG. 7.

FIGS. 6A and 6B are exemplary user interfaces (UI) illustrating mapping information, according to an embodiment. In one embodiment, mapping information in the meta-data associated with an analytic report 500 of FIG. 5 is retrieved. During exporting document using a save-as option, ‘country’, ‘resort’, and ‘pin code’ of the analytic report 500 are mapped to column A 405, column B 410, and column C 415 of the existing document 400B. While comparing, ‘country’ and the column A 405 is not matched. Therefore, an option is provided to map ‘country’ to any of the columns in the existing document 400B. FIG. 6A shows a result of auto mapping 600A as retrieved from the meta-data, according to an embodiment. For example, ‘resort’ and ‘pin code’ are matched with the mapped corresponding columns B 410 and C 415; and ‘country’ is not matched with the corresponding column A 405 as mapped when the save-as option is selected previously (shown as 605). Therefore, a user is provided an option for providing a new mapping information for ‘country’, if required as shown in FIG. 6B.

FIG. 6B shows an option provided for new mapping information, according to an embodiment. Manual mapping 600B includes an option to define a new object mapping 610, wherein a mismatched dimension may be mapped to a header in the existing document by selecting an option ‘select object for mapping’ or can leave the mismatched heading without mapping by selecting an option ‘remove’ object. In one exemplary embodiment, a column ‘nation’ in the existing document is manually mapped with the header ‘country’ of the analytic report shown as 615.

FIG. 7 is an exemplary automatically updated existing document 700 of FIG. 4B, according to an embodiment. In one embodiment, the updated existing document 700 includes additional elements as provided by a user (in the FIG. 4B) for further processing as shown in 705, additional elements as in the refreshed analytic report (FIG. 5) as shown in 710 and also updated element 715. Therefore, the existing document is updated with the additional data using the refreshed analytic report using save-in option automatically.

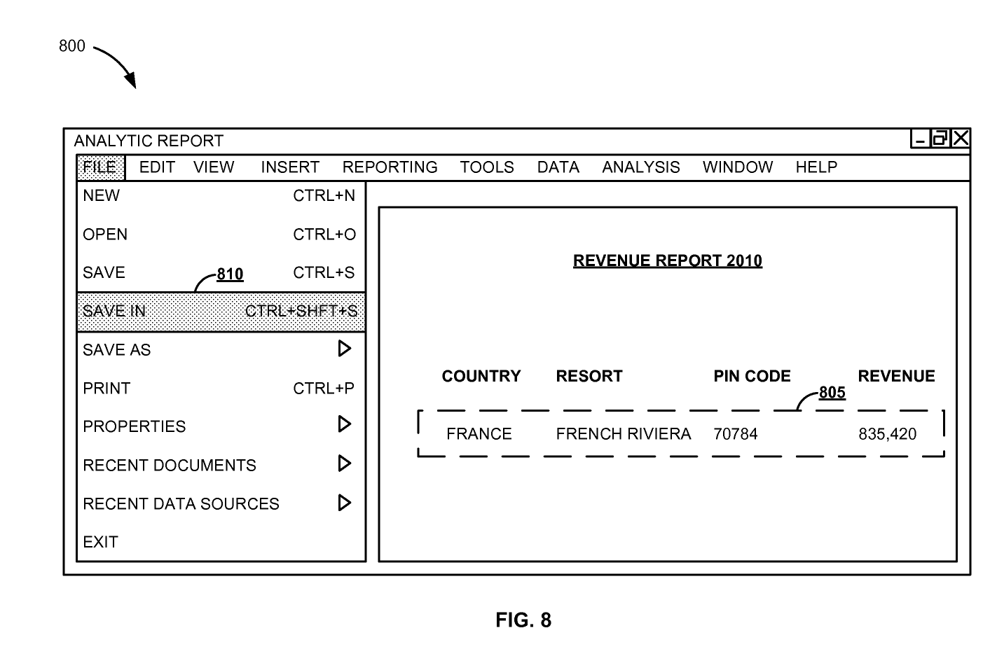

FIG. 8 is another exemplary refreshed analytic report 800 of FIG. 3, according to an embodiment. The refreshed analytic report 800 does not include content or elements as in an analytic report 300 of FIG. 3. In other words, the elements in the analytic report 300 are deleted and a new element 805 is provided in the refreshed analytic report 800. In one embodiment, when a save-in 810 is selected, a user is provided with an option to modify an existing document 400B of FIG. 4 associated with the analytic report 800 by one of retaining the existing document 400B and over writing the existing document 400B as in the analytic report 800.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

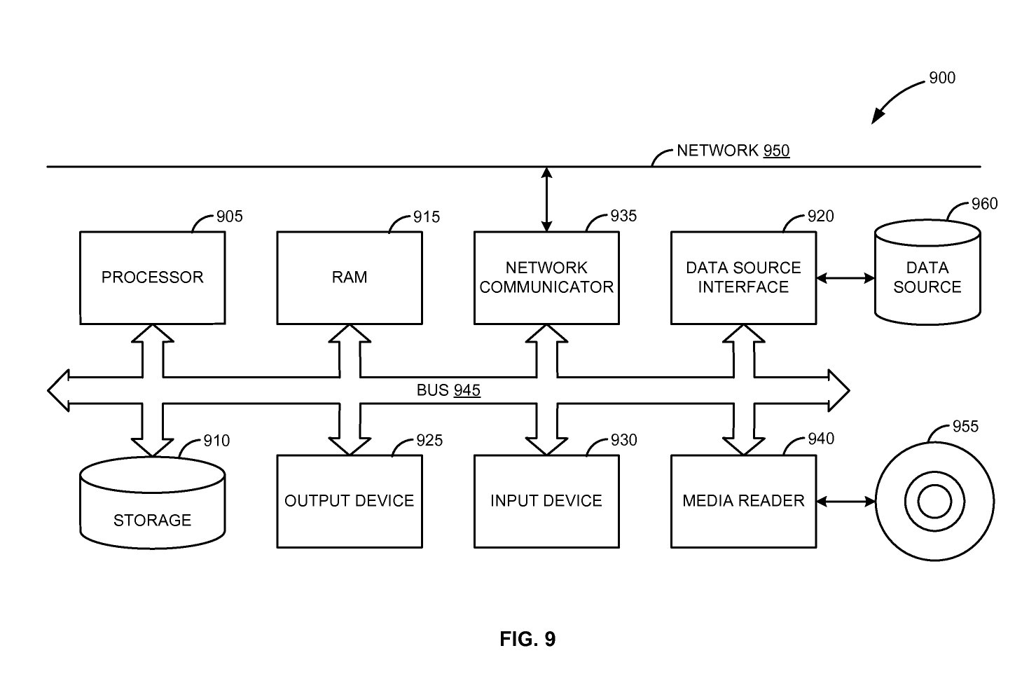

FIG. 9 is a block diagram of an exemplary computer system 900. The computer system 900 includes a processor 905 that executes software instructions or code stored on a computer readable storage medium 955 to perform the above-illustrated methods of the invention. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment of the invention, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive selection of a save-in option for an analytic report;
retrieve meta-data associated with the analytic report, wherein the meta-data comprises location information of an existing document associated with the analytic report and mapping information of the analytic report and the existing document;
compare the analytic report and the existing document using the mapping information; and
update the existing document using the analytic report based on the comparison.

2. The article of manufacture of claim 1, wherein the analytic report is a real time business report.

3. The article of manufacture of claim 1, wherein the meta-data is stored in the analytic report when the analytic report is previously exported using a save-as option.

4. The article of manufacture of claim 1, wherein the mapping information comprises information associated with mapping of one or more dimensions of the analytic report with corresponding one or more dimensions of the existing document.

5. The article of manufacture of claim 1, wherein the existing document comprises one of a document previously exported from the analytic report using a save-as option and a document provided using a change source option.

6. The article of manufacture of claim 5, wherein the mapping information is defined, if the existing document is provided using the change source option.

7. The article of manufacture of claim 1, wherein comparing the analytic report and the existing document further comprises:
converting the analytic report and the existing document into a comparable format;
comparing one or more dimensions of the analytic report with corresponding one or more dimensions of the existing document using the mapping information; and
comparing one or more elements of the analytic report with corresponding one or more elements of the existing document.

8. The article of manufacture of claim 7, wherein the mapping information can be defined, if the one or more dimensions of the existing document are amended.

9. The article of manufacture of claim 1, wherein updating the existing document using the analytic report comprises at least one of:
appending additional elements into the existing document from the analytic report; and
modifying the existing document by one of retaining the existing document and over writing the existing document.

10. A computerized method for automatically updating an existing document associated with an analytic report, the method comprising:
receiving selection of a save-in option for the analytic report;
retrieving meta-data associated with the analytic report, wherein the meta-data comprises location information of the existing document associated with the analytic report and mapping information of the analytic report and the existing document;
comparing the analytic report and the existing document using the mapping information; and
updating the existing document using the analytic report based on the comparison.

11. The computerized method of claim 10, wherein the analytic report is a real time business report.

12. The computerized method of claim 10, wherein the meta-data is stored in the analytic report when the analytic report is previously exported using a save-as option.

13. The computerized method of claim 10, wherein the mapping information comprises information associated with mapping of one or more dimensions of the analytic report with corresponding one or more dimensions of the existing document.

14. The computerized method of claim 10, wherein the existing document comprises one of a document previously exported from the analytic report using a save-as option and a document provided using a change source option.

15. The computerized method of claim 14, wherein the mapping information can be defined, if the existing document is provided using the change source option.

16. The computerized method of claim 10, wherein comparing the analytic report and the existing document further comprises:
converting the analytic report and the existing document into a comparable format;
comparing one or more dimensions of the analytic report with corresponding one or more dimensions of the existing document using the mapping information; and
comparing one or more elements of the analytic report with corresponding one or more elements of the existing document.

17. The computerized method of claim 16, wherein the mapping information can be defined, if the one or more dimensions of the existing document are amended.

18. The computerized method of claim 10, wherein updating the existing document using the analytic report comprises at least one of:
appending additional elements into the existing document from the analytic report; and
modifying the existing document by one of retaining the existing document and over writing the existing document.

19. A computer system for automatically updating an existing document associated with an analytic report, the computer system comprising a processor, the processor communicating with one or more memory devices storing instructions, the instructions operable to:
receive selection of a save-in option for the analytic report;
retrieve meta-data associated with the one analytic report, wherein the meta-data comprises location information of the existing document associated with the analytic report and mapping information of the analytic report and the existing document;
compare the analytic report and the existing document using the mapping information, wherein comparing comprises:
converting the analytic report and the existing document into a comparable format;
comparing one or more dimensions of the analytic report with corresponding one or more dimensions of the existing document using the mapping information; and
comparing one or more elements of the analytic report with corresponding one or more elements of the existing document; and
update the existing document using the analytic report based on the comparison, wherein updating comprises at least one of:
appending additional elements into the existing document from the analytic report; and
modifying the existing document by one of retaining the existing document and over writing the existing document.

20. The system of claim 19, wherein the existing document comprises one of a document previously exported from the analytic report using a save-as option and a document provided using a change source option.
